(19) United States
(12) Patent Application Publication
(10) Pub. No.: US 2012/0063321 A1
(43) Pub. Date: Mar. 15, 2012

(54) CFI Signaling for Heterogeneous Networks with Multiple Component Carriers in LTE-Advanced

(75) Inventors: Vikram Chandrasekhar, Dallas, TX (US); Anthony Ekpenyong, Farmers Branch, TX (US); Runhua Chen, Dallas, TX (US)

(73) Assignee: TEXAS INSTRUMENTS INCORPORATED, Dallas, TX (US)

(21) Appl. No.: 13/050,399

(22) Filed: Mar. 17, 2011

Related U.S. Application Data
(60) Provisional application No. 61/314,647, filed on Mar. 17, 2010.

(51) Int. Cl. H04W 24/00; H04W 52/24

(52) U.S. Cl. 370/241

(57) ABSTRACT

This invention mitigates interference in wireless telephony in heterogeneous networks having a macro base station and a low power base station. This invention attempts to avoid cross carrier scheduling on an anchor carrier and a non-anchor carrier. If cross carrier scheduling is unavoidable, then this invention attempts: (1) semi-statically signalling a CFI value on a cross-scheduled component carrier; (2) semi-statically signalling a channel quality information (CSI) value on a cross-scheduled component carrier setting a Physical Hybrid ARQ Indicator CHannel (PHICH) value to be maximum; or (3) semi-statically signalling a channel quality information (CSI) value on a cross-scheduled component carrier using Physical Control Format Indicator CHannel (PCFICH) power boosting on cross-scheduled component carriers (CC).

### CLAIM OF PRIORITY

This application claims priority under 35 U.S.C. 119(e)(1) to U.S. Provisional Application No. 61/314,647 filed Mar. 17, 2010.

### TECHNICAL FIELD OF THE INVENTION

The technical field of this invention is wireless communication such as wireless telephony.

### BACKGROUND OF THE INVENTION

The problem addressed by this invention arises in a heterogeneous network employing Third Generation Partnership Project (3GPP) TR 25.913 for Evolved Universal Terrestrial Radio Access (E-UTRA) and Evolved Universal Terrestrial Radio Access Network (E-UTRAN) Rel-8 Long Term Evolution (LTE) Advanced. The problem arises when one set of users called cellular users are talking to a conventional macrocell eNodeB, and another set of users are talking to a Low Power Node eNodeB. A Low Power eNodeB is a low power wireless base station such as a Closed Subscriber Group (CSG) Home eNodeB (HeNB), Indoor/Outdoor Picocell or a wireless relay.

In heterogeneous networks employing LTE-Advanced, the downlink Physical Control Format Indicator CHannel (PCFICH) reception at a cellular UE is potentially significantly deteriorated due to cross-tier interference from downlink co-channel transmissions from low power nodes.

### SUMMARY OF THE INVENTION

This invention mitigates Physical Control Format Indicator CHannel (PCFICH) interference problems by using an alternative Control Format Indicator (CFI) signaling mechanism in heterogeneous networks employing LTE-Advanced. This signaling mechanism incurs low overhead, in contrast to alternative dynamic CFI signaling mechanisms.

This invention mitigates interference in wireless telephony when a first user equipment communicates with a first base station and a second user equipment communicates with a second base station having lower transmitter power than the first base station and an overlapping area of coverage with the first base station. This invention determines whether the first user equipment is within or near the area of the second base station and whether the second user equipment is receiving interference from the first base station. These are the conditions when interference is most likely.

This invention includes two different CFI signalling mechanisms depending on whether or not cross-carrier Physical Downlink Control CHannel (PDCCH) signalling is allowed in such a network.

When cross-carrier Physical Downlink Control CHannel (PDCCH) scheduling is allowed and the interfering conditions are met, this invention attempts to avoid cross carrier scheduling on an anchor carrier and a non-anchor carrier. If cross carrier scheduling is unavoidable, then this invention attempts one of three mitigations. These are: first, semi-statically scheduling cross carrier communication; second, scheduling cross carrier communication setting a Physical Hybrid ARQ Indicator CHannel (PHICH) value to be maximum Physical Downlink Control CHannel (PDCCH) control region duration on a Master Information Block (MIB); and third, scheduling cross carrier communication using Physical Control Format Indicator CHannel (PCFICH) power boosting on cross-scheduled component carriers (CC).

In heterogeneous networks with just one carrier including both macro-UEs and LPN UEs without the possibility of cross carrier scheduling, the CFI value is semi-statically signalled on that carrier to user equipments experiencing poor geometry arising from unacceptable cross-tier interference.

### BRIEF DESCRIPTION OF THE DRAWINGS

These and other aspects of this invention are illustrated in the drawings, in which:

FIG. 1 illustrates an exemplary prior art wireless communication system to which this application is applicable;

FIG. 2 shows the Evolved Universal Terrestrial Radio Access (E-UTRA) Time Division Duplex (TDD) frame structure of the prior art;

FIG. 3 illustrates and example heterogeneous network deployment including conventional macro eNodeB(s) and low power nodes;

FIG. 4 illustrates a deployment scenario where two DL CCs include both macro-UEs as well as LPN-UEs; and

FIG. 5 is a block diagram illustrating internal details of a base station and a mobile user equipment in the network system of FIG. 1 suitable for implementing this invention.

### DETAILED DESCRIPTION OF PREFERRED EMBODIMENTS

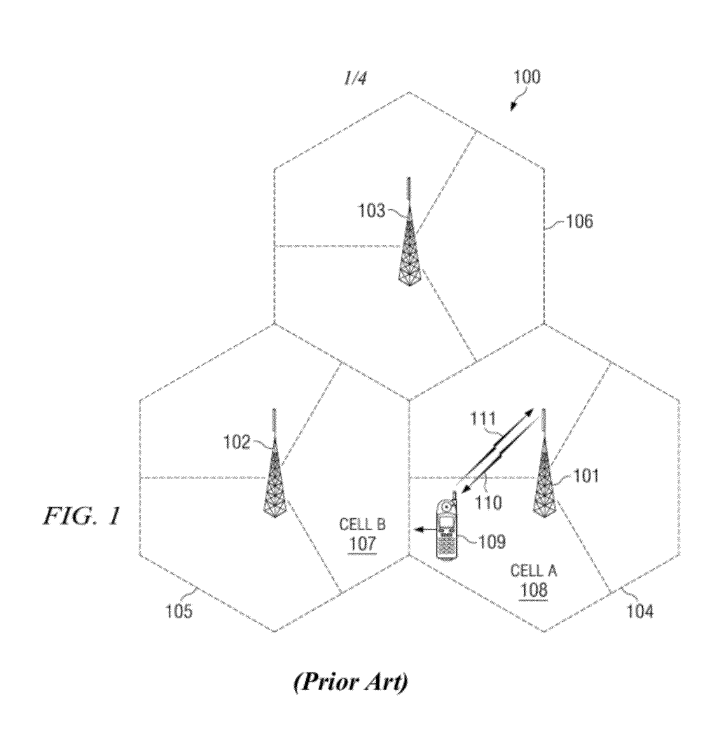

FIG. 1 shows an exemplary wireless telecommunications network 100. The illustrative telecommunications network includes base stations 101, 102 and 103, though in operation, a telecommunications network necessarily includes many more base stations. Each of base stations 101, 102 and 103 (eNB) are operable over corresponding coverage areas 104, 105 and 106. Each base station's coverage area is further divided into cells. In the illustrated network, each base station's coverage area is divided into three cells. Handset or other user equipment (UE) 109 is shown in Cell A 108. Cell A 108 is within coverage area 104 of base station 101. Base station 101 transmits to and receives transmissions from UE 109. As UE 109 moves out of Cell A 108 and into Cell B 107, UE 109 may be handed over to base station 102. Because UE 109 is synchronized with base station 101, UE 109 can employ non-synchronized random access to initiate handover to base station 102.

Non-synchronized UE 109 also employs non-synchronous random access to request allocation of uplink 111 time or frequency or code resources. If UE 109 has data ready for transmission, which may be traffic data, measurements report, tracking area update, UE 109 can transmit a random access signal on uplink 111. The random access signal notifies base station 101 that UE 109 requires uplink resources to transmit the UEs data. Base station 101 responds by transmitting to UE 109 via downlink (DL) 110, a message containing the parameters of the resources allocated for UE 109 uplink transmission along with a possible timing error correction. After receiving the resource allocation and a possible timing advance message transmitted on downlink (DL) 110 by base station 101, UE 109 optionally adjusts its transmit timing and transmits the data on uplink 111 employing the allotted resources during the prescribed time interval.

Base station 101 configures UE 109 for periodic uplink sounding reference signal (SRS) transmission. Base station 101 estimates uplink channel quality information (CSI) from the SRS transmission.

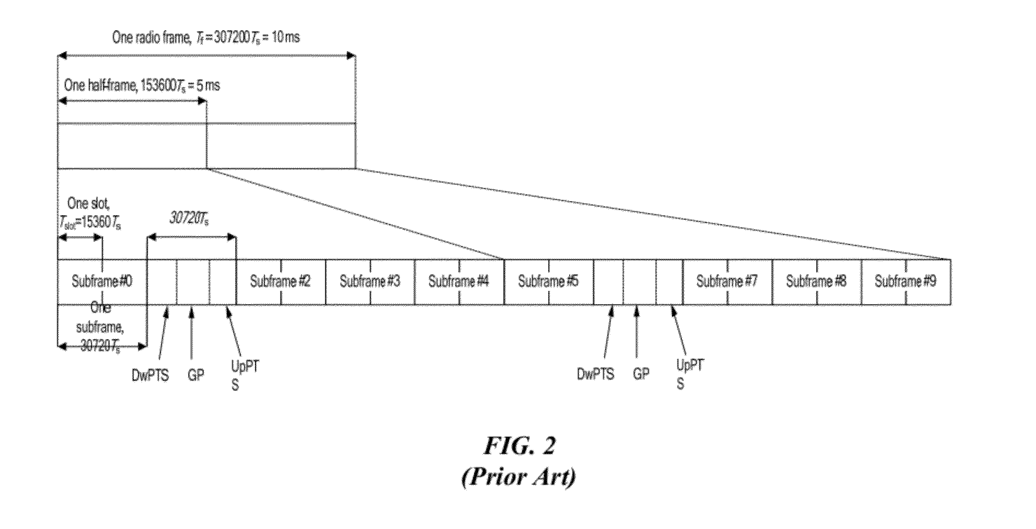

FIG. 2 shows the Evolved Universal Terrestrial Radio Access (E-UTRA) time division duplex (TDD) Frame Structure. Different subframes are allocated for downlink (DL) or uplink (UL) transmissions. Table 1 shows applicable DL/UL subframe allocations.

TABLE 1

| Con- | Switch-point | Sub-frame number | | | | | | | | | |
|---|---|---|---|---|---|---|---|---|---|---|---|
| figuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 10 ms | D | S | U | U | U | D | S | U | U | D |

The problem addressed by this invention arises in a heterogeneous network employing Third Generation Partnership Project (3GPP) TR 25.913 for Evolved Universal Terrestrial Radio Access (E-UTRA) and Evolved Universal Terrestrial Radio Access Network (E-UTRAN) Rel-8 Long Term Evolution (LTE) Advanced. The problem arises when one set of users called cellular users are talking to a conventional macrocell eNodeB, and another set of users are talking to a Low Power Node eNodeB. A Low Power eNodeB is a low power wireless base station such as a Closed Subscriber Group (CSG) Home eNodeB (HeNB), Indoor/Outdoor Picocell or a wireless relay.

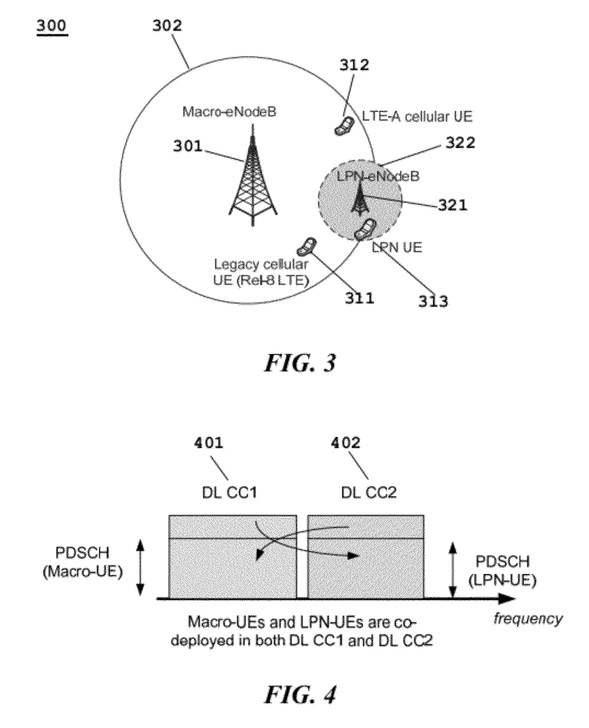

FIG. 3 illustrates one such heterogeneous deployment. System 300 includes normal eNodeB 301 having a radio range 302 communicating with a legacy cellular UE 311, a LTE-A cellular US 312 and a Low Power Node (LPN) UE 314. System 300 also includes Low Power eNodeB 321 having a radio range 322 communicating with Low Power Node (LPN) UE 314. The remainder of this application refers to these heterogeneous classes of eNodeBs as Low Power Nodes (LPNs). For sake of clarity, UEs connected with LPN nodes are called LPN UEs.

In heterogeneous networks employing LTE-Advanced, the downlink Physical Control Format Indicator CHannel (PCFICH) reception at a cellular UE is potentially significantly deteriorated due to cross-tier interference from downlink co-channel transmissions from low power nodes such as noted above.

Assume a heterogeneous network consisting of m downlink component carriers (CC). This application will restrict discussion to m=2 DL CCs. This application discusses two different spectrum deployments and proposes two different CFI signalling mechanisms to combat the interference problem in heterogeneous networks employing LTE-Advanced.

LTE-Advanced supports cross carrier scheduling for conveying Physical Downlink Control CHannel (PDCCH) information on the anchor carrier for UEs receiving their Physical Downlink Shared CHannel (PDSCH) on a non-anchor carrier. Cross-carrier scheduling provides a flexible solution for tackling control channel interference, but the performance of PCFICH detection determining the PDCCH Orthogonal Frequency Division Multiplexing (OFDM) symbol duration with cross-carrier scheduling requires further investigation. Failure to correctly decode PCFICH can lead to PDSCH detection starting from the wrong OFDM symbol. This can result in Hybrid Automatic Repeat Request (HARQ) buffer corruption at the UE. This invention solves problem of erroneous PCFICH detection on a cross-scheduled component carrier in LTE-Advanced.

In homogeneous networks, PCFICH detection for Rel-8 LTE is optimized through power boosting, considering that the PCFICH length is only restricted to 16 Resource Elements (REs). Boosting PCFICH power by 3 or 4 dB, achieves a PCFICH Block Error Rate (BLER) of 10⁻³ to 10⁻⁴. This is comparable to the target BLER for Negative Acknowledgement (NACK) to Acknowledgement (ACK). This is achievable even for a cell-edge UE having a 5 percentile Signal to Interference plus Noise Ratio (SINR) cumulative distribution function (CDF). Thus reliable PCFICH detection is purely an implementation issue in homogeneous networks which may use PCFICH power boosting.

PCFICH detection performance requires further study in heterogeneous network (het-net) deployments, where the random indoor/outdoor locations of users and low power nodes (such as picocells, CSG Home eNodeBs and wireless relays) can introduce serious near-far problems at both the macro UEs and het-net UEs.

FIG. 4 illustrates a deployment scenario where two DL CCs can consist of macro-UEs as well as LPN-UEs. A typical dual carrier deployment would consist of all macro-UEs being cross-scheduled from DL CC1 401. In this example DL CC1 401 is the anchor carrier for macro-UEs). All LPN-UEs are cross-scheduled from DL CC2 402. DL CC2 402 is the anchor carrier for LPN UEs). This deployment does not preclude Rel-8 LTE UEs being present in either carrier. Considering the scarcity of available spectrum, it is more likely than not that LTE-A UEs and Rel-8 LTE UEs will be multiplexed in both DL CCs.

PDCCH for macro-UEs on DL CC2 402 (in contrast to LPN UEs on DL CC1 401) may be transmitted at lower power to facilitate inter-cell interference coordination for reliable PDCCH detection on either component carrier. Power reduction on PDCCH on a non-anchor component carrier facilitates reliable PDCCH detection on the UEs on the tier for which that CC is the anchor carrier. In this example this is either the macro-UE or LPN tier. While PDCCH power de-boosting on the macro-UEs on DL CC2 (in contrast to LPN UEs on DL CC1 401) reduces cross-tier interference on the control region for UEs belonging to the other tier, PCFICH performance requires further study especially for UEs experiencing substantially poor geometries. There are the following two categories.

In Category 1, cell-edge macro-UE is in the vicinity of a hostile LPN interferer such as a CSG HeNB or a non-serving hotzone cell.

In Category 2, the LPN UE experiences significant interference from an interfering macrocell eNodeB. For example, its serving CSG HeNB may be physically located close to a macro eNodeB.

Alternative cell selection schemes such as range extension, which was originally proposed for higher offloading in the context of hotzone cell deployments, are now called into question. These schemes can cause UEs to associate with a cell which is not necessarily their strongest cell and may create increased interference over both uplink and downlink directions. In the current context, a het-net UE may experience increased PCFICH interference arising from the choice of cell-selection. Any potential PCFICH problems in het-net deployments may require re-visiting the scenarios in which the underlying problems surface, rather than changing PCFICH design itself.

This application examines the problems associated with L1-based dynamic CFI signalling. These include contemporary proposals wherein the CFI value on a cross-scheduled carrier is conveyed either implicitly, for example by Cyclic Redundancy Check (CRC) masking of the PDCCH with the CRC plus the CFI masked User Equipment IDentity (UEID), or through explicit signalling using an entirely new CFI signalling scheme. Alternative implicit schemes specify the CFI value on the non-anchor carrier to always equal the PDCCH symbol duration on the anchor carrier. Such schemes do not satisfy the previous agreement on independent PDCCH duration on separate component carriers. Proponents of a purely implementation based solution state that dynamically signalling the CFI value on the anchor carrier can lead to a host of new problems.

Two such problems of dynamic CFI signalling are described below:

Problem A: If the PCFICH on the non-anchor carrier is set to a smaller value (for example 1 OFDM symbol), the PDSCH on the non-anchor carrier can experience PDCCH interference transmitted at full power from the interfering eNodeB. Thus, dynamic CFI indication may help solve the PCFICH detection problem, but may lead to increased PDSCH interference.

Problem B: For Rel-8 LTE macro-UEs on DL CC2 (in contrast to Rel-8 LTE LPN-UEs on DL CC1], reliable PCFICH coverage is not guaranteed.

For these reasons, the applicants believe is that a fully L1-based CFI signalling is not yet sufficiently justified for LTE-A. This application includes four strategies for enhancing PCFICH detection performance in het-nets, if needed, and further discuss their pros and cons.

Strategy A: Never cross-schedule UEs which fall in either Category 1 or 2.

Strategy B: Set the Physical Hybrid ARQ Indicator CHannel (PHICH) value to be the maximum PDCCH control region duration on the Master Information Block (MIB). Note that the PHICH duration is a lower bound on the PDCCH symbol duration.

Strategy C: Use PCFICH power boosting on cross-scheduled CC.

Strategy D: CFI for a cross-scheduled UE shall be semi-statically signalled if it falls in either Category 1 or Category 2.

Strategies A, B and C offer the advantage of being purely implementation based solutions. In strategy B, since the PDCCH OFDM symbol size on the non-anchor carrier is held to be a fixed maximum, the PCFICH field on the non-anchor carrier is decoded only by Rel-8 UEs falling in that carrier. The main problem with strategy B is that there is a worst-case PDCCH efficiency loss equalling 14% that may be triggered by transmitting 3 PDCCH OFDM symbols when just one PDCCH symbol would suffice. This may be relevant for LPNs with few connected users experiencing good coverage to their serving eNodeB.

Strategy C requires further study, since PCFICH in Rel-8 LTE has been designed for robust performance, keeping in mind its extremely low coding rate, two bit CFI values are mapped to 32 bit codewords corresponding to an effective rate of 0.0625, the inherent frequency diversity in its RE to frequency domain mapping and the presence of a cell-specific frequency offset. It is plausible that PCFICH power boosting may well work in het-net deployment scenarios as well.

Strategy A is an even simpler implementation based solution because it relies on interference avoidance and eNodeB scheduler design. Strategy A does not attempt to solving the problem, if tries to avoid the problem. A combination of Strategies A, B and C could be employed. This combination would use Strategy A when a mobile LTE-A user moves into an environment where there is significant interference such as when the LTE-A UE wanders into a Category-1/2 scenario for a limited duration. For a Rel-8 LTE macro-UE, either Strategy B or C or a combination of both could be employed.

Strategy D attempts to strike a balance between dynamic L1 signalling and an implementation based solution. Semi-static signalling can provide almost all of the advantages of L1-signalling while reducing signalling overhead.

As a special case Strategies B, C and D are well suited to ensure adequate PCFICH coverage for low geometry UEs falling in Category 1 or Category 2 in het-net scenarios with a single component carrier where cross-carrier scheduling in not possible.

This application seeks to resolve PCFICH detection with multiple component carriers for LTE-Advanced. For homogeneous network deployments, the applicants believe that PCFICH power boosting can solve any potential PCFICH detection problem. In heterogeneous network deployments, the applicants believe that the PDSCH start symbol on cross-scheduled carriers can be determined either through semi-static signalling or through implementation-based approaches.

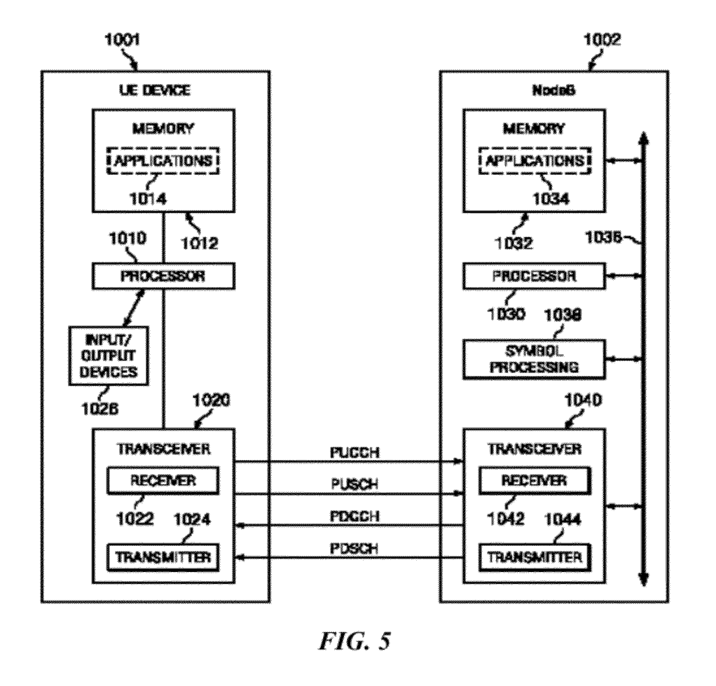

FIG. 5 is a block diagram illustrating internal details of an eNB 1002 and a mobile UE 1001 in the network system of FIG. 1. Mobile UE 1001 may represent any of a variety of devices such as a server, a desktop computer, a laptop computer, a cellular phone, a Personal Digital Assistant (PDA), a smart phone or other electronic devices. In some embodiments, the electronic mobile UE 1001 communicates with eNB 1002 based on a LTE or Evolved Universal Terrestrial Radio Access Network (E-UTRAN) protocol. Alternatively, another communication protocol now known or later developed can be used.

Mobile UE 1001 comprises a processor 1010 coupled to a memory 1012 and a transceiver 1020. The memory 1012 stores (software) applications 1014 for execution by the processor 1010. The applications could comprise any known or future application useful for individuals or organizations. These applications could be categorized as operating systems (OS), device drivers, databases, multimedia tools, presentation tools, Internet browsers, emailers, Voice-Over-Internet Protocol (VOIP) tools, file browsers, firewalls, instant messaging, finance tools, games, word processors or other categories. Regardless of the exact nature of the applications, at least some of the applications may direct the mobile UE 1001 to transmit UL signals to eNB (base-station) 1002 periodically or continuously via the transceiver 1020. In at least some embodiments, the mobile UE 1001 identifies a Quality of Service (QoS) requirement when requesting an uplink resource from eNB 1002. In some cases, the QoS requirement may be implicitly derived by eNB 1002 from the type of traffic supported by the mobile UE 1001. As an example, VOIP and gaming applications often involve low-latency uplink (UL) transmissions while High Throughput (HTP)/Hypertext Transmission Protocol (HTTP) traffic can involve high-latency uplink transmissions.

Transceiver 1020 includes uplink logic which may be implemented by execution of instructions that control the operation of the transceiver. Some of these instructions may be stored in memory 1012 and executed when needed by processor 1010. As would be understood by one of skill in the art, the components of the uplink logic may involve the physical (PHY) layer and/or the Media Access Control (MAC) layer of the transceiver 1020. Transceiver 1020 includes one or more receivers 1022 and one or more transmitters 1024.

Processor 1010 may send or receive data to various input/output devices 1026. A subscriber identity module (SIM) card stores and retrieves information used for making calls via the cellular system. A Bluetooth baseband unit may be provided for wireless connection to a microphone and headset for sending and receiving voice data. Processor 1010 may send information to a display unit for interaction with a user of mobile UE 1001 during a call process. The display may also display pictures received from the network, from a local camera, or from other sources such as a Universal Serial Bus (USB) connector. Processor 1010 may also send a video stream to the display that is received from various sources such as the cellular network via RF transceiver 1020 or the camera.

During transmission and reception of voice data or other application data, transmitter 1024 may be or become non-synchronized with its serving eNB. In this case, it sends a random access signal. As part of this procedure, it determines a preferred size for the next data transmission, referred to as a message, by using a power threshold value provided by the serving eNB, as described in more detail above. In this embodiment, the message preferred size determination is embodied by executing instructions stored in memory 1012 by processor 1010. In other embodiments, the message size determination may be embodied by a separate processor/memory unit, by a hardwired state machine, or by other types of control logic, for example.

eNB 1002 comprises a Processor 1030 coupled to a memory 1032, symbol processing circuitry 1038, and a transceiver 1040 via backplane bus 1036. The memory stores applications 1034 for execution by processor 1030. The applications could comprise any known or future application useful for managing wireless communications. At least some of the applications 1034 may direct eNB 1002 to manage transmissions to or from mobile UE 1001.

Transceiver 1040 comprises an uplink Resource Manager, which enables eNB 1002 to selectively allocate uplink Physical Uplink Shared CHannel (PUSCH) resources to mobile UE 1001. As would be understood by one of skill in the art, the components of the uplink resource manager may involve the physical (PHY) layer and/or the Media Access Control (MAC) layer of the transceiver 1040. Transceiver 1040 includes at least one receiver 1042 for receiving transmissions from various UEs within range of eNB 1002 and at least one transmitter 1044 for transmitting data and control information to the various UEs within range of eNB 1002.

The uplink resource manager executes instructions that control the operation of transceiver 1040. Some of these instructions may be located in memory 1032 and executed when needed on processor 1030. The resource manager controls the transmission resources allocated to each UE 1001 served by eNB 1002 and broadcasts control information via the PDCCH.

Symbol processing circuitry 1038 performs demodulation using known techniques. Random access signals are demodulated in symbol processing circuitry 1038.

During transmission and reception of voice data or other application data, receiver 1042 may receive a random access signal from a UE 1001. The random access signal is encoded to request a message size that is preferred by UE 1001. UE 1001 determines the preferred message size by using a message threshold provided by eNB 1002. In this embodiment, the message threshold calculation is embodied by executing instructions stored in memory 1032 by processor 1030. In other embodiments, the threshold calculation may be embodied by a separate processor/memory unit, by a hardwired state machine, or by other types of control logic, for example. Alternatively, in some networks the message threshold is a fixed value that may be stored in memory 1032, for example. In response to receiving the message size request, eNB 1002 schedules an appropriate set of resources and notifies UE 1001 with a resource grant.

1. A method of mitigating interference in wireless telephony when a first user equipment communicates with a first base station and a second user equipment communicates with a second base station having lower transmitter power than the first base station and an overlapping area of coverage with the first base station comprising the steps of:
determining whether the first user equipment is within or near the area of the second base station;
determining whether the second user equipment is receiving interference from the first base station; and
if the first user equipment is within or near the area of the second base station or if the second user equipment is receiving interference from the first base station, then prohibiting cross carrier scheduling for conveying Physical Downlink Control CHannel (PDCCH) information on an anchor carrier for the first and second user equipments receiving their Physical Downlink Shared CHannel (PDSCH) on a non-anchor carrier.

2. The method of claim 1, further comprising the step of:
if the first user equipment is within or near the area of the second base station or if the second user equipment is receiving interference from the first base station and cross carrier scheduling is not possible, then semi-statically signalling a channel quality information (CSI) value on a cross-scheduled component carrier to the user equipment experiencing poor geometry arising from unacceptable cross-tier interference.

3. The method of claim 1, further comprising the step of:
if the first user equipment is within or near the area of the second base station or if the second user equipment is receiving interference from the first base station and prohibiting cross carrier scheduling is not possible, then semi-statically signalling a channel quality information (CSI) value on a cross-scheduled component carrier for conveying Physical Downlink Control CHannel (PDCCH) information on an anchor carrier for the first and second user equipments receiving their Physical Downlink Shared CHannel (PDSCH) on a non-anchor carrier.

4. The method of claim 1, further comprising the step of:
if the first user equipment is within or near the area of the second base station or if the second user equipment is receiving interference from the first base station and prohibiting cross carrier scheduling is not possible, then semi-statically signalling a channel quality information (CSI) value on a cross-scheduled component carrier setting a Physical Hybrid ARQ Indicator CHannel (PHICH) value to be maximum Physical Downlink Control CHannel (PDCCH) control region duration on a Master Information Block (MIB).

5. The method of claim 1, further comprising the step of:
if the first user equipment is within or near the area of the second base station or if the second user equipment is receiving interference from the first base station and prohibiting cross carrier scheduling is not possible, then semi-statically signalling a channel quality information (CSI) value on a cross-scheduled component carrier using Physical Control Format Indicator CHannel (PCFICH) power boosting on cross-scheduled component carriers (CC).

6. The method of claim 1, further comprising the step of:
if the first user equipment is within or near the area of the second base station or if the second user equipment is receiving interference from the first base station and prohibiting cross carrier scheduling is not possible, then performing a selected one of (1) semi-statically signalling a channel quality information (CSI) value on a cross-scheduled component carrier for conveying Physical Downlink Control CHannel (PDCCH) information on an anchor carrier for the first and second user equipments receiving their Physical Downlink Shared CHannel (PDSCH) on a non-anchor carrier, (2) semi-statically signalling a channel quality information (CSI) value on a cross-scheduled component carrier setting a Physical Hybrid ARQ Indicator CHannel (PHICH) value to be maximum Physical Downlink Control CHannel (PDCCH) control region duration on a Master Information Block (MIB) or (3) semi-statically signalling a channel quality information (CSI) value on a cross-scheduled component carrier using Physical Control Format Indicator CHannel (PCFICH) power boosting on cross-scheduled component carriers (CC).
